(19) United States
(12) Patent Application Publication
(10) Pub. No.: US 2006/0085519 A1
(43) Pub. Date: Apr. 20, 2006

(54) Method and apparatus providing domain-based cache storage for a mobile internet browser

(76) Inventors: Brian Goode, Winchester, MA (US); David Carson, Roslindale, MA (US)

Correspondence Address: HARRINGTON & SMITH, LLP, 4 RESEARCH DRIVE, SHELTON, CT, 06484-6212, US

(21) Appl. No.: 10/966,532

(22) Filed: Oct. 14, 2004

(51) Int. Cl. G06F 15/16

(52) U.S. Cl. 709/218

(57) ABSTRACT

A system is disclosed for storing content received from a data communications network. The system includes at least one physical memory device for implementing a cache memory and a cache memory manager responsive to content received from at least two sources for associating an identifier with content stored in the at least one physical memory device that distinguishes content received from a first source from content received from a second source. The cache memory manager is further responsive to the identifiers for performing at least one cache management function differently for the content received from the first source than for the content received from the second source. In a mobile station embodiment that includes a HTTP browser the invention permits HTTP content received from a wireless network operator to be stored and managed separately from other received HTTP content.

### TECHNICAL FIELD

This invention relates generally to browsers and, more specifically, relates to Internet browsers used in mobile communications and data processing devices.

### BACKGROUND

An aspect of operating a mobile Internet browser, such as one found in a mobile phone device, relates to how the browser stores or caches content into the device's memory and/or file storage system. At present, many mobile Internet browsers offer content caching capabilities. Typically, the browser caches all mark-up language content and images that are loaded while the user is “browsing”. The browser then examines the cache inventory when future load requests are made, and uses the cached content (if available) in lieu of re-loading the content over the wireless network.

The cache “size” is the amount of memory or file-system space dedicated to storing the cached items. Typically, items remain in the cache until either: a) the user manually clears the cache; b) the specific item expires (individual items may have header information that defines an expiry date); or c) the cache becomes full, at which point an algorithm is applied, such as a Least Recently Used (LRU) algorithm, to determine which cached items should be deleted to make room for new items

Mobile Internet browsers are commonly used to access a portal or a gateway defined by a wireless service provider, also referred to herein as an “operator”. Many mobile phones are delivered to the end-customer with their internal browser pre-configured to access the operator's home page or portal. As a result, the content that exists on the operator-created web page(s) may typically be the most commonly accessed content.

While the generic browser caching model works well in general, and works well particularly for “random” web browsing, the inventors have realized that the generic browser caching model can be less than optimum for those users who regularly load a certain operator's home page. This is true at least for the reason that subsequent browsing activities by the user may result in the operator's content being removed from the cache. Since the operator's content is frequently accessed as the first page loaded by the browser, and is potentially returned to often, the standard cache model is clearly not optimal, as it can require repeated accesses over the wireless network to the operator's gateway or portal to re-load the operator's content, thereby reducing the overall system bandwidth and possibly adding cost for the user.

### SUMMARY OF THE PREFERRED EMBODIMENTS

The foregoing and other problems are overcome, and other advantages are realized, in accordance with the presently preferred embodiments and teachings in accordance with this invention.

In one aspect of the embodiments of this invention there is provided a system for storing content received from a data communications network. The system includes at least one physical memory device for implementing a cache storage and a cache manager that identifies and distinguishes content received from at least one specifically-identified source from content received from other sources. The cache manager is further responsive to at least one distinguishing identifier for performing at least one cache management function differently for the content received from the at least one specifically-identified source from content received from the other sources.

In another aspect of the embodiments of this invention there is provided a computer program embodied on a computer readable medium, such as a disk and/or a semiconductor memory, for directing a data processor to store content in at least one physical memory device implementing a cache storage, where the content is received from a data communications network, by operations that include, responsive to content received from at least two sources, associating an identifier with content stored in the at least one physical memory device that distinguishes content received from a first source from content received from a second source and, responsive to the identifiers, performing at least one cache management function differently for the content received from the first source than for the content received from the second source.

In a further aspect of the embodiments of this invention there is provided a mobile station that includes a wireless transceiver for coupling the mobile station to the Internet via a wireless network operator. The transceiver is coupled to a data processor that is coupled to at least one physical memory. The data processor operates to implement a Hypertext Transfer Protocol (HTTP) browser function to load HTTP content via a wireless network. The data processor further operates to implement a HTTP cache management function for storing at least some loaded HTTP content in the at least one physical memory. The HTTP cache management function is operable to associate a first identifier with stored HTTP content that is loaded from a Universal Resource Locator (URL) that is associated with the wireless network operator and to associate a second identifier with stored HTTP content that is loaded from a URL that is not associated with the wireless network operator and, responsive to the identifiers, to perform at least one cache management function differently for the stored HTTP content loaded from the URL that is associated with the wireless network operator than for the stored HTTP content that is loaded from the URL that is not associated with the wireless network operator.

In a still further aspect of the embodiments of this invention there is provided a mobile station having at least one physical memory means for implementing a cache storage for storing content received from a data communications network via a wireless receiver means. The mobile station further includes means, responsive to content received from at least two sources, for associating an identifier with content stored in the at least one physical memory device that distinguishes content received from a first source from content received from a second source, and means, responsive to the identifiers, for performing at least one cache management function differently for the content received from the first source than for the content received from the second source.

In one still further aspect of the embodiments of this invention there is provided a mobile station that includes HTTP browser means; first cache means for storing first HTTP content received via a wireless receiver means and second cache means for storing second HTTP content received from the wireless receiver means. The first cache means stores only received HTTP content associated with a wireless network operator, and the second cache means stores received HTTP content from at least one other content source.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a system level block diagram of a mobile station and a wireless network operator, and represents one suitable embodiment of practicing the embodiments of this invention;

FIG. 2 is a logic flow diagram that is illustrative of the operation of the browser and cache manager of FIG. 1 in accordance with embodiments of this invention; and

FIG. 3 is a block diagram that shows in greater detail the construction of the cache manager of FIG. 1 and related components.

### DETAILED DESCRIPTION OF THE PREFERRED EMBODIMENTS

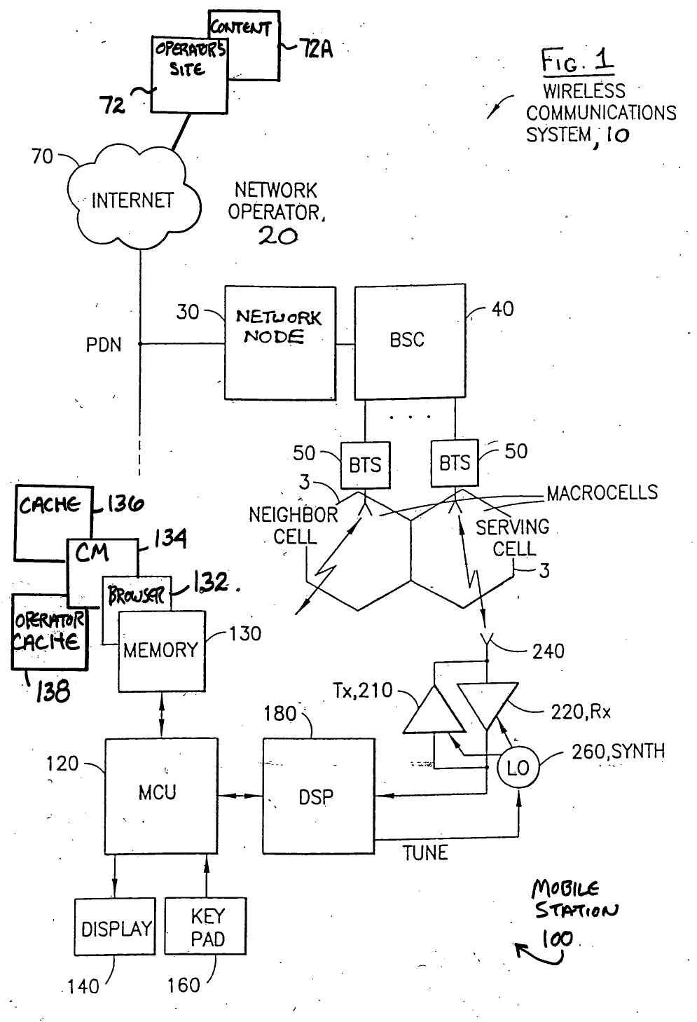

By way of introduction, and referring to FIG. 1, there is shown as a simplified block diagram an embodiment of a wireless communications system 10 that is suitable for practicing the embodiments of this invention. The wireless communications system 10 includes at least one mobile station (MS) 100. FIG. 1 also shows an exemplary network operator 20 having, for example, a node 30 for connecting to a telecommunications network, such as a Public Packet Data Network or PDN, at least one base station controller (BSC) 40 or equivalent apparatus, and a plurality of base transceiver stations (BTS) 50, also referred to as base stations (BSs), that transmit in a forward or downlink direction both physical and logical channels to the mobile station 100 in accordance with a predetermined air interface standard. A reverse or uplink communication path also exists from the mobile station 100 to the network operator, which conveys mobile originated access requests and traffic. A cell 3 is associated with each BTS 50, where one cell will at any given time be considered to be a serving cell, while an adjacent cell(s) will be considered to be a neighbor cell. Smaller cells (e.g., picocells) may also be available.

It should be appreciated that while FIG. 1 shows the mobile station 100 primarily in the context of a cellular wireless communications system, in other embodiments of this invention the mobile station 100 may instead, or in addition, interface with a wireless local area network (WLAN), and/or with a Bluetooth™ wireless network (either RF or IR), or with any other type of wireless communications network.

The air interface standard can conform to any suitable standard or protocol, and may enable both voice and data traffic, such as data traffic enabling Internet 70 access and web page downloads. Coupled via the Internet 70 is assumed to be an operator's site 72 having content 72A that is downloadable to the MS 100.

In the presently preferred embodiments of this invention the air interface standard may be compatible with a code division multiple access (CDMA) air interface standard, such as one known as cdma2000, although this is not a limitation upon the practice of this invention as the invention may be practiced using any air interface protocol that supports the delivery of digital data to the MS 100.

The mobile station 100 typically includes a control unit or control logic, such as a microcontrol unit (MCU) 120 having an output coupled to an input of a display 140 and an input coupled to an output of a keyboard or keypad 160.

The MCU 120 is assumed to include or be coupled to some type of a memory 130, including a non-volatile memory for storing an operating program and other information, as well as a volatile memory for temporarily storing required data, scratchpad memory, received packet data, packet data to be transmitted, and the like. The operating program is assumed, for the purposes of this invention, to enable the MCU 120 to execute the software routines, layers and protocols required to implement the methods in accordance with this invention, as well as to provide a suitable user interface (UI), via display 140 and keypad 160, with a user. Although not shown, a microphone and speaker are typically provided for enabling the user to conduct voice calls in a conventional manner.

In the preferred embodiments of this invention the memory 130 includes software for implementing an Internet browser 132 that includes a cache manager (CM) function 134 for interacting with a cache 136 wherein Internet content is stored, such as the content 72A downloaded from the operator's site 72.

In the presently preferred embodiments of this invention the browser 132 is assumed to be HTTP (Hypertext Transfer Protocol) compliant, specifically HTTP/1.1 as defined by the W3C (www.w3c.org) in RFC 2616. HTTP is an application-level protocol for distributed, collaborative, hypermedia information systems. It is a generic, stateless, protocol which can be used for many tasks beyond its use for hypertext, such as name servers and distributed object management systems, through extension of its request methods, error codes and headers. A feature of HTTP is the typing and negotiation of data representation, allowing systems to be built independently of the data being transferred. HTTP has been in use by the World Wide Web global information initiative since 1990. RFC 2616 defines the protocol referred to as “HTTP/1.1”, and is an update to RFC 2068. However, compliance with HTTP/1.1 is not a limitation upon the practice of this invention.

In accordance with an aspect of this invention, and as will be described in further detail below, there is also provided a separate operator cache (OC) 138 that is also managed by the CM 134. Note that the operator cache 138 may be a separate memory region as shown, or it may form a pre-defined portion of the cache 136 that is managed differently than the remainder of the cache 136. In the preferred embodiments of this invention the operator-specific content is distinguished from other content by an appended identifier, referred to for convenience below as a GroupID. By means of the GroupID different types of content can be stored in one common physical memory and subsequently distinguished from one another based on their respective values of GroupID. Alternatively, the different types of content can be stored in different physical memories, such as persistent memory for the operator-specific items (the operator cache 138) versus and normal RAM memory for other types of content (the cache 136). The value of the GroupID in this case can be used to determine to which type of physical memory the associated content should be directed.

To complete the description of FIG. 1, the mobile station 100 also contains a wireless section that includes a digital signal processor (DSP) 180, or equivalent high speed processor or logic, as well as a wireless transceiver that includes a transmitter 200 and a receiver 220, both of which are coupled to an antenna 240 for communication with the network operator. At least one local oscillator, such as a frequency synthesizer (SYNTH) 260, is provided for tuning the transceiver. Data, such as digitized voice and packet data, is transmitted and received through the antenna 240.

The mobile station 100 may be a handheld radiotelephone, such as a cellular telephone or a personal communicator. The mobile station 100 could also be contained within a card or module that is connected during use to another device. For example, the mobile station 100 could be contained within a PCMCIA or similar type of card or module that is installed during use within a portable data processor, such as a laptop or notebook computer, or a computer that is wearable by the user.

In general, the various embodiments of the MS 100 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions (e.g., a cellular telephone that includes an image capture device and an Internet browser). Further, and as was alluded to above, while the wireless transceiver 210, 220 may be a radio frequency (RF) cellular transceiver, in other non-limiting and exemplary embodiments it may be a low power RF transceiver, such as a Bluetooth transceiver, or a wireless LAN transceiver, or a even an optical transceiver, such as an IR transceiver. In a wired network embodiment the transceiver can be coupled to an electrical or an optical cable.

The presently preferred embodiments of this invention provide a technique and system for the operator-specific content 72A to be treated separately from normal Internet content in regards to caching mechanisms. Specifically, the operator may provide an operator-specific domain Universal Resource Locator (URL or Internet “location”) that the content 72A is loaded from. The content 72A that is associated with the operator-specific domain is treated separately from normal web content, and the size and storage location of the operator cache 138 may be specified to be different from the cache 136 used for “normal” Internet content (i.e., Internet content received during normal, possibly random Internet browsing).

In general, a URL includes the protocol (ex. HTTP, FTP), the domain name (or IP address), and additional path information (folder/file). On the Web, a URL may address a Web page file, image file, or any other file supported by the HTTP protocol. An example of a URL is: http://www.foobar.com/webpages/information/.

The embodiments of this invention may be implemented by defining a set of persistent settings on the MS 100, typically to be provisioned by the operator, to store at least the identification of the operator domain (URL) as a domain used to compare incoming content with. For example, www.operator.com/menu/ signifies that content loaded whose URL begins with “www.operator.com/menu/” is cached in the operator-specific cache 138. The set of persistent settings on the MS 100 also stores an operator cache size, typically in kilobytes, of the cache 138 dedicated to the domain-specific operator content. The set of persistent settings on the MS 100 may also store an operator cache folder containing an optional location, typically on a platform-specific file system, where the domain-specific cached content is stored. Other embodiments may alternatively use some suitable identification mechanism and store all items in the cache location. The operator cache folder may also provide the ability to store the domain-specific cache items in a location separate for the standard cache location (e.g., in the cache 138 versus the cache 136) as it is preferred that the domain-specific cache folder be located in persistent memory (e.g., flash memory or hard-drive). This ensures that the content of the operator cache 138 is retained through MS 100 power cycles, even if the “normal” cache 136 is in RAM and therefore cleared during power cycles.

The foregoing presently preferred embodiments of this invention may be further extended by making modifications to the standard caching mechanism of the browser 132 and cache manager 134. These modifications may include adding a one byte field, referred to for convenience as “GroupID”, for each item in the cache which identifies the group to which the cached content belongs. For example, a GroupID value of 0x01 may be used to specify operator cache 138 items, a GroupID value of 0x00may be used to refer to the normal web content for the cache 136, while a GroupID value of 0x80 may imply that the entry has been deleted or is expired. Using this one byte field it becomes possible to store 256 different groups of cache content.

In operation, and referring to FIG. 2, when a new cache entry is created because of a new HTTP (load) response (block A), the URL of the content is checked to see if it matches the operator domain (block B) and is assigned the appropriate GroupID (0x00=no, 0x01=yes) based on the result of the comparison (block C). When a new file is created to store the response in the cache (block D), the path of the file is determined based on the GroupID and operator cache 138 folder setting.

When the cache size of a particular group is full, entries belonging to that group are deleted according to the cache manager 134 cache clearing policy to make room for the new entry. The LRU clearing policy is one that is suitable for use. It should be noted, however, that the cache clearing policies may differ for the cache 136 versus the operator cache 138.

While the user is browsing, and when content is requested from a web server, the URL of the entry is checked against the operator domain setting and assigned the GroupID of operator cache (0x01) if it matches. Otherwise, the normal cache groupID (0x00) is assigned. The entry URL is then matched against the entries of that GroupID, to see if the response exists in cache. Cache expiration mechanisms and cache timing calculations may function the same as for normal web content. When the cache is cleared by the user, only the entries with the normal cache GroupID (0x00) are deleted (those entries stored in cache 136), while the contents of the operator cache 138 are preserved.

A specific implementation API definition of a function that is used to check if cache content is operator content is given below:

| | |
|---|---|
| Function: | HTTP_Cache_Mgr_IsOpCacheContent |

| | Parameter | |
|---|---|---|
| Parameter type | name | Purpose |
| HTTP_CacheMgr | aCacheMgr | A pointer to the filter's instance |
| | | of Cache Manager |
| const TDesC8& | aUrl | URL of the entry being checked. |

| Return type | Description |
|---|---|
| TBool | ETrue if the content is Operator specific and |
| | EFalse if not. |

The use of the presently preferred embodiments of this invention provides several advantages to the user and operator in comparison to the conventional caching scheme. For the user, the most frequently accessed Internet content can be displayed more quickly. Since the dedicated cache store 138 for the operator can be located in persistent memory, the primary pages can be available for display on the MS 100 even after a power cycle, without having to save the entire browser cache 136. Also, and depending upon the manner in which the operator 20 bills the user for data connections, the use of this caching mechanism may reduce the user's costs, as potentially fewer downloads of operator content are required over the wireless network. For the operator, this functionality makes Internet access from the MS 100 more enjoyable for the end-user, by providing faster and more reliable access to the top-level pages. These pages may be designed to focus the user on operator-provided content and services, which can then lead to increased data connection time and revenue.

It is noted that the use of the separate operator cache 138 may not require separate file-system resources (e.g., memory or disk space), as it may share the normal cache storage. The size of the operator cache 138 may be provisioned so that the operator (or the user) may reduce the size of, or eliminate altogether, the operator cache 138 if desired.

As a further embodiment, particularly useful if the operator's content is actually being derived from multiple domains (and thus is not encompassed by a single URL), the comparison step (block B of FIG. 2) may compare against a plurality of domains and/or domain fragments. For example, for the case where specifying the domain as the matching criteria may be limiting, one may instead match against a “list” of URL fragments that may include, as examples: sub-domains and/or domain/path definitions. Note that while the foregoing embodiments are described in the context of the use of the single operator-specific cache 138, in other embodiments of this invention multiple special caches may be employed, including at least one that is user-defined. For example, assume that the user often visits a certain site. In this case the user may then employ user interface and other software in the memory 130, that operates with the cache manger 134, to establish (possibly in persistent memory) and manage a special cache that is dedicated for use with that site, whereby the loaded content is managed separately from the normal cache content in the cache 136. When the user is finished browsing that site the user may delete the associated special cache, thereby freeing MS 100 resources.

Wired network browsers, typically hosted on more robust PC platforms, normally do not have the same limitations as to cache size as the wireless network browser 132 hosted on amobile platform. However, embodiments of this invention as they pertain to the use of at least one separate, special purpose cache may also be applied to the wired network browser. For example, an “advanced” user may be provided the opportunity to set up multiple, specific caches with, as non-limiting examples: separate lists of target URLs/fragments, rules concerning types of content to cache, separate storage limits, separate time-out/expiry conditions, and/or toggles to enable/disable the specific cache (to take the caching “offline” when needed). Note that the rules concerning types of content to cache can be extended beyond the URL domain/sub-domain level for both the wireless and wired browsers. For example, it may be desirable to establish separately managed caches for different types of content, such as for audio content, web pages, and documents. In this case different GroupIDs may be established by the cache manager 134 for identifying different types of content and thus different logical areas in the cache 136. The operator cache may thus be considered to be but one example of such a distinguishable logical area in the cache 136, referred to for convenience in FIG. 1 as the operator cache 138. Each such cache may be located in the same physical memory, or they may be located in different physical memories depending on whether, for example, persistent cache storage is desired for the particular cached content.

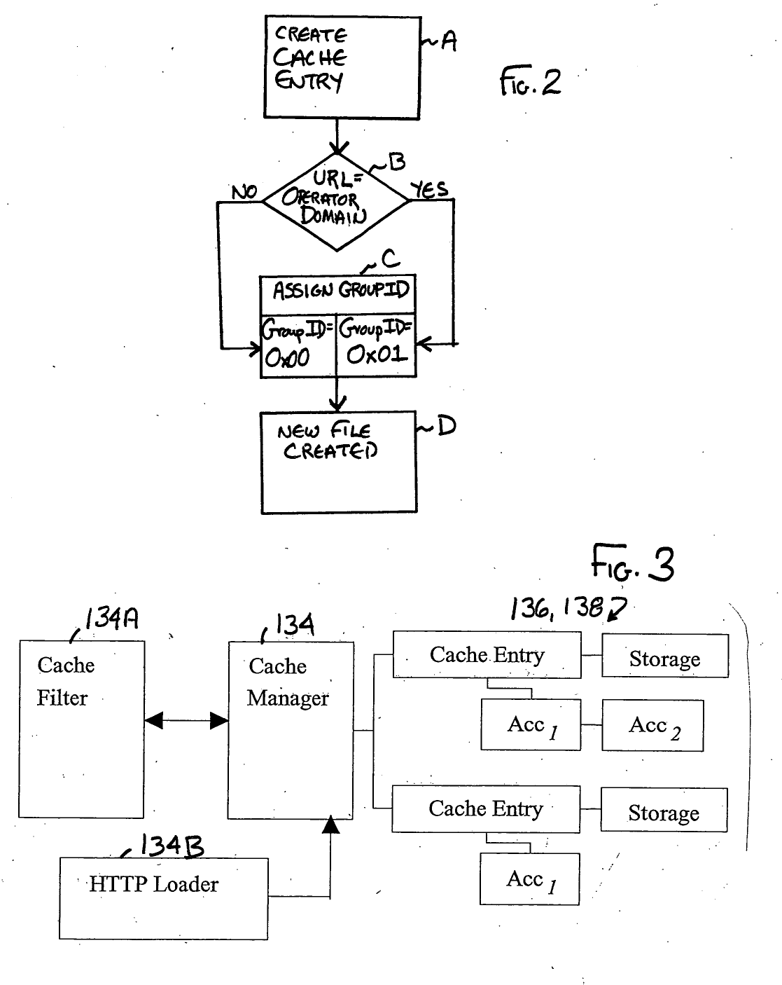

Describing aspects of the foregoing now in further detail, reference is made to FIG. 3 for showing a block diagram of the cache manager 134 of FIG. 1 and related components. The HTTP cache manager 134 acts as a high level internal interface and is coupled to a cache filter 134A and a HTTP loader 134B. When the cache is active a small amount of dynamic memory is used to track active entries and the requests accessing them. The cache manager 134 stores the cached resources in a file. The number of entries in the cache manager 134 may be any convenient number, such as 256.

In a presently preferred embodiment the cache 136/138 contains one item in persistent storage per cached resource. The cache manager 134 does not maintain an in-memory list of cached resources. Instead, resources are fetched from the persistent memory as needed. Entries that are being written to or read from are considered to active. Active entries are partially loaded from persistent memory and stored in a list. As entries become inactive, they are removed from the list. The larger parts of an entry, such as the URL, header, and body are read from persistent memory, used, and discarded as needed.

When the HTTP loader 134B receives a new response, the request and response information is passed to the cache manager 134 and a new cache entry is created. As the HTTP loader receives additional portions of a response, they too are passed to the cache manager 134 and are appended to the associated entries. When the HTTP loader 134B core determines that a resource is complete, it notifies the cache manager 134 which marks the entry as completed. Once entries are completed, requests are allowed to access them.

In order to facilitate access to cache entries, the meta information of the persistent entry is stored as a CacheMetaEntry in a separate MetaEntry File. The MetaEntry information is used to access the actual persistent cache resource. At startup, the cache manager 134 reads the meta entries from the MetaEntry file and stores them in a single linked list. The cache manager 134 also registers with the file system of the MS 100 to be notified of any write events to the MetaEntry file. When the MetaEntry file changes, cache manager 134 updates its list of meta entries. Before accessing a MetaEntry file, cache manager 134 checks if the file has been modified so that it can update its entries. Each client of the cache manager 134 creates an instance of Cache Manager (HTTP Cache_Mgr) to gain access to cached resources. The Cache Manager provides a streaming interface to clients to store responses and to retrieve them.

In operation, the cache filter 134A resides in a HTTP stack and uses the cache manager 134 to retrieve and to store cached resources. The cached resources are stored in a file in the file system, and may be stored in a pre-defined location.

The following Class descriptions are herewith defined:

| Class | Description |
|---|---|
| HTTP_Cache_Mgr | The Cache Manager 134 provides a high |
| | level API for accessing cached resources |
| | on persistent storage. |
| HTTP_Cache_Entry | Encapsulates cached entry information. |
| | Entries are created as needed to provide |
| | access to resources in persistent storage. |
| | An entry may have one writer or multiple |
| | readers. |
| HTTP_Cache_MetaEntry | Encapsulates the meta information of an |
| | entry (hash key, data size, and file |
| | name) for ease of access to the actual |
| | cached entries. |
| HTTP_Cache_Storage | HTTP_Cache_Storage is a cache entry level |
| | wrapper. The storage is able to create |
| | and destroy HTTP_Cache_Entry, as well as |
| | read, append, and update entries. |
| HTTP_Cache_Accessor | Encapsulates the state of a read or write |
| | operation on an entry (shown as blocks |
| | ACCₙ in FIG. 3). |

In a presently preferred, but non-limiting embodiment of this invention the HTTP_Cache_MetaEntry is used to store a cached resource's meta entry information, such as a keyHash used to identify the resource, the length of the key, body size, and the last time this resource was accessed. This is created when the resource is created on the cache 132, 138 and updated to the file, so that the index is reserved and is updated with the response information when the response is complete.

In a presently preferred, but non-limiting embodiment of this invention the HTTP_Cache_Storage is the high level wrapper to the actual persistent storage, and the HTTP_Cache_Entry is used to access the entry, and also store information useful in loading the resource from persistent storage. More specifically, the HTTP_Cache_Entry stores the offsets for the URL, headers and body. A list of active entries is stored in the cache manager 134, so the offsets are read only once in the beginning when accessing the resource.

As was discussed above, the HTTP operator cache 138 provides a mechanism for the operator-specific content to be treated separately from normal web content in regards to caching mechanisms. Specifically, an operator may provide an operator-specific domain URL, and any content that falls under that domain is treated separately from normal web content. The size limitation and storage folder for this content may be specified to be different from normal content. The content of the operator cache 138 is not cleared by a User Clear cache action.

The operator (O) domain, operator cache size and operator cache folder are specified by the following entries in an initialization (ini) file of the cache manager 134.

ODomainUrl is the domain information of the operator content. The filename is stripped from this entry to obtain the domain information. For example, if the domain URL is given as http://www.foo.com/pathlbar.html, the domain information is arrived at as http://www.foo.com/path/. The default value in the ini file for this key is NULL, and no content is considered as operator content.

OCacheSize is the size of the operator cache 138. The default value in the ini file for this key is zero.

OCacheDir is the location where the operator cache 138 contents are stored. The default value in the ini file for this key is d:\cache.

The operator cache 138 is preferably implemented by making but minor modifications to the cache manger 134 software module. Each entry in the cache 136 has the one byte field referred to above as GroupID, and the GroupID with a value of 0x01 is defined as specifying the operator cache 138. When a new entry is requested from the server, the URL of the entry is checked against the operator domain and assigned the GroupID of the operator cache 138 if it matches, otherwise the normal cache 136 GroupID is assigned. The entry URL is then matched against the entries of that GroupID to see if the response exists in the cache 138.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. For example, the use of other similar or equivalent browser types and mobile station and wireless network architectures may be attempted by those skilled in the art. However, all such and similar modifications of the teachings of this invention will still fall within the scope of this invention.

Furthermore, some of the features of the present invention could be used to advantage without the corresponding use of other features. As such, the foregoing description should be considered as merely illustrative of the principles of the present invention, and not in limitation thereof.

What is claimed is:

1. A system for storing content received from a data communications network, comprising:
at least one physical memory device for implementing a cache storage; and
a cache manager that identifies and distinguishes content received from at least one specifically-identified source from content received from other sources, the cache manager further being responsive to at least one distinguishing identifier for performing at least one cache management function differently for the content received from the at least one specifically-identified source from content received from the other sources.

2. A system as in claim 1, where the content comprises Hypertext Transfer Protocol content, and where the specifically-identified source is distinguished from the other sources based on a Universal Resource Locator that the content is loaded from.

3. A system as in claim 1, where the content comprises Hypertext Transfer Protocol content, and where the specifically-identified source is distinguished from the other sources based on at least a portion of a Universal Resource Locator that the content is loaded from.

4. A system as in claim 1, where the content is loaded from a wired network.

5. A system as in claim 1, where the content is loaded from a wireless network.

6. A system as in claim 5, where one of the specifically-identified source and the other source is associated with a wireless network operator.

7. A system as in claim 1, where the at least one cache management function comprises selecting a type of physical memory that the content associated with the specifically-identified source is stored in.

8. A system as in claim 1, where the at least one cache management function comprises selecting a deletion policy for determining when to remove the stored content.

9. A system as in claim 1, where the at least one cache management function comprises selecting a size of the associated cache storage that the content associated with the specifically-identified source is stored in.

10. A system as in claim 1, where the at least one cache management function comprises selecting a location of the associated cache storage that the content associated with the specifically-identified source is stored in.

11. A system as in claim 1, where the at least one cache management function comprises one of selectively retaining or deleting content associated with the specifically-identified source.

12. A system as in claim 1, where said cache manager comprises a user interface for enabling a user to specify that content received from the specifically-identified source be managed differently than content received from another source.

13. A system as in claim 12, where said cache manager is responsive to the user interface for assigning a unique identifier to be associated with the content received from the specifically-identified source.

14. A computer program embodied on a computer readable medium for directing a data processor to store content in at least one physical memory device implementing a cache memory, where the content is received from a data communications network, by operations comprising:
responsive to content received from at least two sources, associating an identifier with content stored in the at least one physical memory device that distinguishes content received from a first source from content received from a second source; and
responsive to the identifiers, performing at least one cache management function differently for the content received from the first source than for the content received from the second source.

15. A computer program as in claim 14, where the content comprises Hypertext Transfer Protocol content, and where the first source is distinguished from the second source based on a Universal Resource Locator that the content is loaded from.

16. A computer program as in claim 14, where the content comprises Hypertext Transfer Protocol content, and where the first source is distinguished from the second source based on at least a portion of a Universal Resource Locator that the content is loaded from.

17. A computer program as in claim 14, where the content is loaded from a wired network.

18. A computer program as in claim 14, where the content is loaded from a wireless network.

19. A computer program as in claim 18, where one of the first source and the second source is associated with a wireless network operator.

20. A computer program as in claim 14, where the at least one cache management function comprises selecting a type of physical memory that the content associated with a particular identifier is stored in.

21. A computer program as in claim 14, where the at least one cache management function comprises selecting a deletion policy for determining when to remove the stored content.

22. A computer program as in claim 14, where the at least one cache management function comprises selecting a size of the associated cache memory that the content associated with a particular identifier is stored in.

23. A computer program as in claim 14, where the at least one cache management function comprises selecting a location of the associated cache memory that the content associated with a particular identifier is stored in.

24. A computer program as in claim 14, where the at least one cache management function comprises one of selectively retaining or deleting content associated with a particular identifier.

25. A computer program as in claim 14, further comprising operating a user interface coupled to said cache memory manager to enable a user to specify that content received from a particular source be managed differently than content received from another source.

26. A computer program as in claim 25, further comprising an operation, responsive to the user interface, to assign a unique identifier to be associated with the content received from the particular source.

27. A mobile station, comprising a wireless transceiver for coupling the mobile station to the Internet via a wireless network operator, said transceiver being coupled to a data processor that is coupled to at least one physical memory, said data processor operating to implement a Hypertext Transfer Protocol (HTTP) browser function to load HTTP content via a wireless network, said data processor further operating to implement a HTTP cache management function for storing at least some loaded HTTP content in said at least one physical memory, said HTTP cache management function operable to associate a first identifier with stored HTTP content that is loaded from a Universal Resource Locator (URL) that is associated with the wireless network operator and to associate a second identifier with stored HTTP content that is loaded from a URL that is not associated with the wireless network operator and, responsive to the identifiers, to perform at least one cache management function differently for the stored HTTP content loaded from the URL that is associated with the wireless network operator than for the stored HTTP content that is loaded from the URL that is not associated with the wireless network operator.

28. A mobile station as in claim 27, where the at least one cache management function comprises selecting a type of physical memory that the HTTP content associated with a particular identifier is stored in.

29. A mobile station as in claim 27, where the at least one cache management function comprises selecting a deletion policy for determining when to remove the stored HTTP content.

30. A mobile station as in claim 27, where the at least one cache management function comprises selecting a size of the associated cache memory that the HTTP content associated with a particular identifier is stored in.

31. A mobile station as in claim 27, where the at least one cache management function comprises selecting a location of the associated cache memory that the HTTP content associated with a particular identifier is stored in.

32. A mobile station as in claim 27, where the at least one cache management function comprises one of selectively retaining or deleting HTTP content associated with a particular identifier.

33. A mobile station as in claim 27, further comprising a user interface coupled to said HTTP cache management function to enable a user to specify that HTTP content received from a particular URL, or a portion of a particular URL, be managed differently than content received from another URL.

34. A mobile station as in claim 33, said HTTP cache management function further operable, responsive to said user interface, to assign a unique identifier to be associated with the HTTP content received from said particular URL, or from said portion of a particular URL.

35. A mobile station, comprising at least one physical memory means for implementing a cache memory for storing content received from a data communications network via a wireless receiver means; means, responsive to content received from at least two sources, for associating an identifier with content stored in the at least one physical memory device that distinguishes content received from a first source from content received from a second source; and means, responsive to the identifiers, for performing at least one cache management function differently for the content received from the first source than for the content received from the second source.

36. A mobile station, comprising HTTP browser means; first cache memory means for storing first HTTP content received via a wireless receiver means and second cache memory means for storing second HTTP content received from said wireless receiver means; where said first cache memory means stores only received HTTP content associated with a wireless network operator, and where said second cache memory means stores received HTTP content from at least one other content source.

37. A mobile station as in claim 36, further comprising cache manager means operable to execute at least one cache management function differently for said first cache memory means that for said second cache memory means.

38. A mobile station as in claim 37, where the at least one cache management function comprises at least one of selecting a deletion policy for determining when to remove the stored HTTP content, selecting a size of the cache memory means, selecting a location of the cache memory, and one of selectively retaining or deleting stored HTTP content.

39. A mobile station as in claim 37, further comprising user interface means for enabling a user to specify that HTTP content received from a particular source be managed differently than HTTP content received from another source.

40. A mobile station as in claim 39, further comprising cache memory manager means responsive to said user interface means for assigning a unique Group Identifier to be associated with stored HTTP content received from the particular source.
